(19) United States
(12) Patent Application Publication
(10) Pub. No.: US 2008/0060889 A1
(43) Pub. Date: Mar. 13, 2008

(54) BRAKING PRESSURE CONTROL UNIT FOR VEHICLE BRAKING SYSTEM

(76) Inventor: Matsuhisa TSURUTA, Toyoya-city (JP)

Correspondence Address: BUCHANAN, INGERSOLL & ROONEY PC, POST OFFICE BOX 1404, ALEXANDRIA, VA, 22313-1404, US

(21) Appl. No.: 11/851,538

(22) Filed: Sep. 7, 2007

(30) Foreign Application Priority Data
Sep. 8, 2006 (JP) 2006-244423

(51) Int. Cl. B60T 7/12

(52) U.S. Cl. 188/110

(57) ABSTRACT

An object of the invention is to fix a control circuit board to a casing unit and then the casing unit to a block in a simple structure and with a small number of parts. A metal rod is integrally formed with a partitioning wall of the casing unit. One axial end of the metal rod is fixed to the control circuit board, so that the control circuit board is fixed to the casing unit via the metal rod. On the other hand, the other end of the metal rod is fixed to the solenoid block, so that the casing unit is fixed to the solenoid block via the metal rod. Thus, the control circuit board and the casing unit are fixed to the solenoid block by the single member of the metal rod.

### CROSS REFERENCE TO RELATED APPLICATION

This application is based on Japanese Patent Application No. 2006-244423 filed on Sep. 8, 2006, the disclosure of which is incorporated herein by reference.

### FIELD OF THE INVENTION

The present invention relates to a braking pressure control unit for a vehicle braking system.

### BACKGROUND OF THE INVENTION

A braking pressure control unit for a vehicle braking system is known in the art, for example, as disclosed in Japanese Patent Publication No. 2000-159081. As shown in FIGS. 1 to 3 of this prior art, a casing 9 is fixed to an upper side of a housing 12 of a hydraulic unit by screws 29a to 29d, which are inserted into four through-holes 31a to 31d of the casing 9 and screwed into screw holes 69a to 69d of the housing 12. Four fixing claws 27a to 27d are formed at the casing 9 and the fixing claws are inserted into fixing holes 35a to 35d provided in an electric printed circuit board 4, so that the printed circuit board 4 is fixed to an upper side of the casing 9.

In the above mentioned braking pressure control unit, multiple screws 29a to 29d are used and multiple through-holes 31a to 31d are formed in order to fix the casing 9 to the housing 12 of the hydraulic unit. Accordingly, it is a problem that the casing 9 may become larger by spaces for the through-holes 31a to 31d, and a number of parts is increased to thereby increase the cost thereof. It is also a problem that the manufacturing cost for the casing 9 is increased, because the fixing claws 27a to 27d are formed at the casing 9. It is a further problem that the size of the printed circuit board 4 is increased by the spaces for the fixing holes 35a to 35d.

Furthermore, in the above mentioned braking pressure control unit, as disclosed in Japanese Patent Publication No. 2000-159081, a ground bus bar 19a (to be connected to the ground) for an electric motor (not shown) is connected at a through-hole 31d. The bus bar 19a is finally connected to the ground through the housing 12 of the hydraulic unit. In this braking system, however, since a ground circuit for the electric motor is formed by the bus bar 19a, the number of parts is increased to increase the cost. In addition, the assembling process is not simple.

According to another conventional braking system, which is shown in FIGS. 2 and 4 of Japanese Patent No. 3,365,055, an electronic control unit 110 is arranged in an inside of a cover member 106. A base plate 110A is thermally in contact with a heat transferring plate 111 at a side, which is opposite to a side to which a flexible printed circuit board is attached. The heat transferring plate 111 is made of an aluminum alloy and fixed to a casing 106A by two screw members 112, such that the heat transferring plate 111 is displaceable in an up-and-down direction in FIG. 4. The heat transferring plate 111 is biased towards a body 102 by wave washers interposed between the screw members 112 and the heat transferring plate 111. The heat transferring plate 111 has four leg portions 111a, which penetrate through the casing 106A and are thermally in contact with the body 102. According to the above conventional braking system, the heat of the base plate 110A is transferred to the heat transferring plate 111 and radiated to the air. However, since the heat transferring plate 111 is provided, the cover member 106 becomes inevitably larger in its size. As a result, the size of the braking pressure control unit is correspondingly made larger. In addition, a number of parts is increased and thereby the cost becomes higher.

According to a further conventional braking system, which is shown in FIGS. 2 and 4 of Japanese Patent Publication No. 2002-193086, a filter device 53 is provided at a portion between a casing 50 and a connector member 52. The filter device 53 (which has an auriferous but water proof function) allows that ventilation may be carried out between an accommodating chamber 542 for a printed circuit board and the outside, and between a connector chamber 55 and the outside, but water flow into the inside is prevented. The filter device 53 is arranged at an end of a partitioning portion of the casing 50, so that the filter device 53 opens to both of the accommodating chamber 542 and the connector chamber 55. As a result that the filter device 53 is provided, the pressure in the accommodating chamber 542 and the connector chamber 55 becomes equal to the atmospheric pressure, so that the pressure in the accommodating chamber 542 is prevented from becoming to a negative value. Thus, the pressure in the accommodating chamber 542 is prevented from becoming to the negative value by the filter device 53. However, it is a problem that a number of parts is increased and the cost becomes higher.

### SUMMARY OF THE INVENTION

The present invention is made in view of the foregoing problems, and has an object to provide a braking pressure control unit for a vehicle, in which an electric printed circuit board is fixed to a casing, and the casing is fixed to a hydraulic unit, with a simple structure and with a smaller number of parts.

According to a feature of the present invention, a braking pressure control unit for a vehicle braking system has a block having an assembling side, to which multiple electromagnetic valves for performing brake control operation of a vehicle are attached, and a control circuit board for controlling operations of the electromagnetic valves. The braking pressure control unit further is has a casing made of synthetic resin and fixed to the block for covering the electromagnetic valves, wherein the casing has an open end fluid-tightly fixed to the assembling side of the block. A partitioning wall defines, within a space of the casing, a first chamber for accommodating the electromagnetic valves and a second chamber for accommodating the control circuit board, the partitioning wall being made of synthetic resin and opposing to the control circuit board. And a metal rod is integrally formed with the partitioning wall, wherein one end of the metal rod is fixed to the control circuit board whereas the other end of the metal rod is fixed to the block.

According to another feature of the present invention, the metal rod is fixed to the block by a bolt.

According to a further feature of the present invention, one axial end of the metal rod is in contact with a ground conductive pattern formed on the control circuit board.

According to a further feature of the present invention, an electrically conductive and heat transferring material is interposed between the one axial end of the metal rod and the ground conductive pattern.

According to a still further feature of the present invention, the metal rod is integrally formed with a boss portion provided at the partitioning wall, wherein the metal rod penetrates through the boss portion, a supporting portion is formed by the metal rod and the boss portion, and a labyrinth structure is formed in the supporting portion, wherein the labyrinth structure communicates the first and second chambers with each other and prevents water from directly flowing into the second chamber from the first chamber.

According to a still further feature of the present invention, the labyrinth structure is arranged at such a position, which is higher than a maximum water level, which may be achieved when pressure in the first chamber becomes negative and water comes into the first chamber.

According to a still further feature of the present invention, the labyrinth structure has a communication groove or a communication hole, which is formed at least at one of the boss portion and the metal rod.

According to a still further feature of the present invention, the labyrinth structure has a cylindrical shielding wall, which is integrally formed with the boss portion and extends in the axial direction along the metal rod, so that the shielding wall covers an open end of the communication groove or the communication hole on a side of the first chamber.

According to a still further feature of the present invention, a step portion is formed at the open end of the communication groove or the communication hole on the side of the first chamber, wherein the step portion is formed at an outer peripheral surface of the metal rod or an inner peripheral surface of the cylindrical shielding wall.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a braking pressure control unit for a vehicle according to an embodiment of the present invention;

FIG. 2 is a cross sectional view taken along a line II-II in FIG. 1;

FIG. 3 is a cross sectional view taken along a line III-III in FIG. 2;

FIG. 4 is a cross sectional view taken along a line IV-IV in FIG. 3;

FIG. 5 is a cross sectional view taken along a line V-V in FIG. 4;

FIG. 6 is a cross sectional view showing a modification for fixing a control circuit board to a metal rod;

FIG. 7 is a cross sectional view showing a modification, in which a communication groove is formed in a boss portion;

FIG. 8 is a cross sectional view showing a modification, in which a communication hole is formed in a boss portion; and

FIG. 9 is a cross sectional view showing a modification for fixing a casing to a brake actuator.

### DETAILED DESCRIPTION OF THE PREFERRED EMBODIMENTS

An embodiment of the present invention for a braking pressure control unit for a vehicle will be explained with reference to the attached drawings.

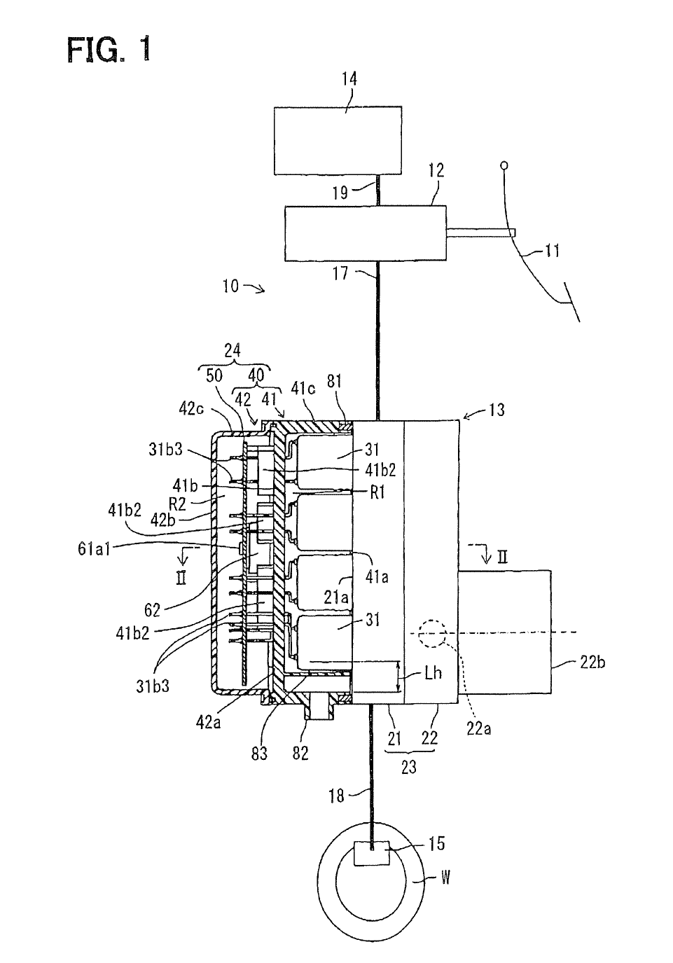

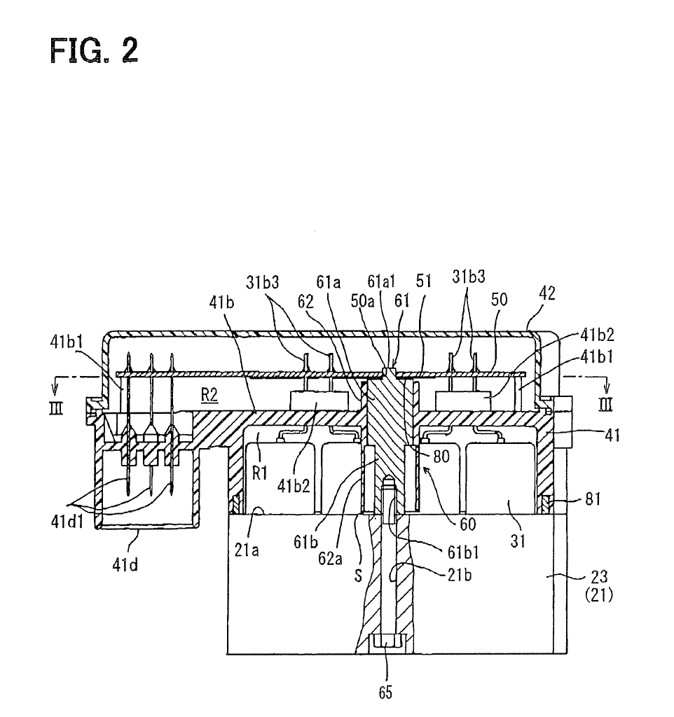

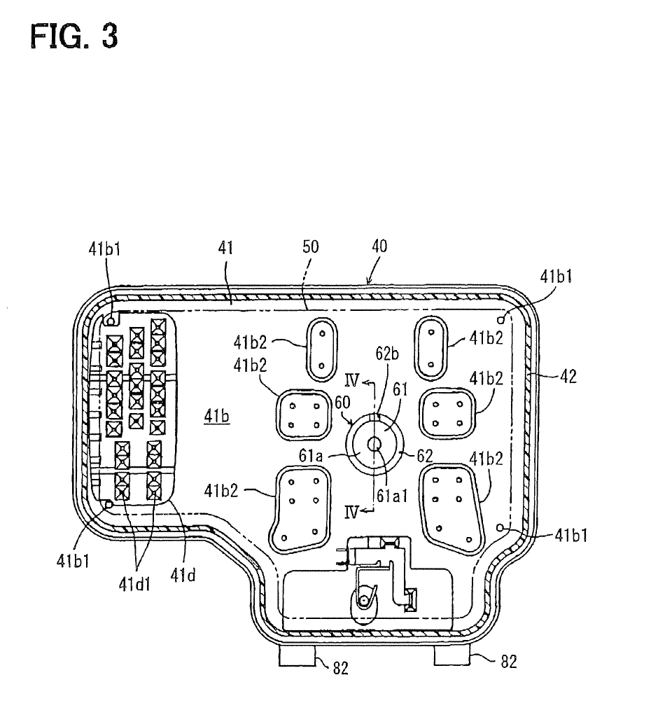

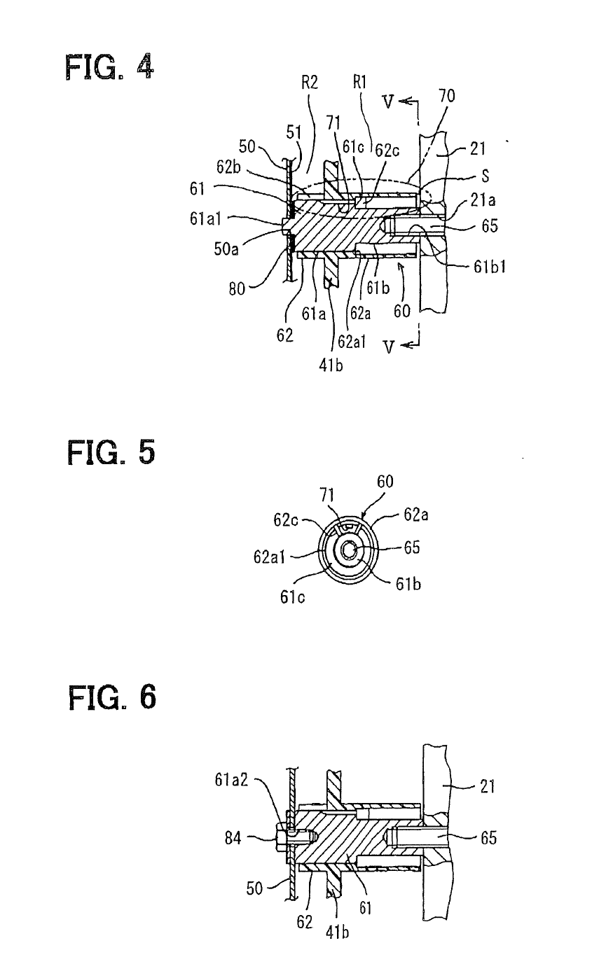

FIG. 1 shows a schematic view of a vehicle hydraulic braking system 10, to which a braking pressure control unit 13 for a vehicle is applied. FIG. 2 is a cross sectional view taken along a line II-II in FIG. 1, FIG. 3 is a cross sectional view taken along a line III-III in FIG. 2, FIG. 4 is a cross sectional view taken along a line IV-IV in FIG. 3, and FIG. 5 is a cross sectional view taken along a line V-V in FIG. 4.

The vehicle hydraulic braking system 10 applies a braking force to a vehicle wheel W. As shown in FIG. 1, the vehicle hydraulic braking system 10 has a master cylinder 12, the braking pressure control unit 13, a reservoir tank 14 and a braking unit (a wheel cylinder) 15. The master cylinder 12 produces hydraulic pressure, which corresponds to a brake pedal force generated by an operation of a brake pedal 11, so that the hydraulic pressure is applied to the braking unit 15 for suppressing rotation of the vehicle wheel W.

The braking pressure control unit 13 is composed of a single unified structure having a brake actuator 23 and a casing unit 24, wherein the brake actuator 23 has a solenoid block 21 and a pump block 22. The reservoir tank 14 stores brake fluid and supplies the brake fluid to the master cylinder 12 and the brake actuator 23. More exactly, the reservoir tank 14 re-supplies the brake fluid to the master cylinder 12 through a fluid pipe 19. As shown in FIG. 1, the braking pressure control unit 13 is installed in a vehicle so that a drain port 82 of the braking pressure control unit 13 is directed to a downward direction. In FIGS. 1 and 3, up-and-down directions in the drawing correspond to the vertical direction of the vehicle.

The solenoid block 21 is communicated to the master cylinder 12 through a fluid pipe 17, and to the braking unit 15 through a fluid pipe 18, respectively. Multiple fluid passages are formed in the solenoid block 21, so that those fluid passages are connected to the fluid pipes 17 to 19 and a pump 22a. The solenoid block 21 is made of a metal.

Multiple solenoid valves 31 (that is, electromagnetic valves for a pressure holding valve, a pressure decreasing valve, a pressure control valve, and so on) and a pressure sensor (not shown) for detecting fluid pressure of the brake fluid are incorporated into the solenoid block 21, in such a manner that those solenoid valves 31 as well as the pressure sensor are arranged in the respective fluid passages. According to such a structure, the fluid pressure of the master cylinder 12 is applied to the selected braking unit (or units) 15, and/or the fluid pressure from the pump 22a is applied to each of the braking units 15 or to the selected braking unit (or units) 15.

The solenoid valves 31 are fixed to the solenoid block 21, such that a solenoid portion of each solenoid valve 31 protrudes into a first chamber R1 (in a leftward direction in FIG. 1). Terminal portions 31b3 of each solenoid valve 31 penetrate through a partitioning wall 41b, and forward ends thereof are soldered to a printed circuit board (an electronic control circuit board) 50.

The pump block 22 is fluid-tightly fixed to a surface of the solenoid block 21, which is an opposite side (a right hand side) to an assembling surface 21a of the solenoid block 21. The pump block 22 is made of a metal. Multiple fluid passages are formed in the pump block 22, so that those fluid passages are communicated with the corresponding fluid passages formed in the solenoid block 21. The pump 22a is arranged in the fluid passages. The pump 22a is driven by an electric motor 22b, which is also incorporated into the pump block 22, to draw the brake fluid from a reservoir in the brake actuator 23.

The brake actuator 23 is a braking pressure control device, which is separately provided from the master cylinder 12 and which is capable of generating the fluid pressure depending on the braking operation carried out by the brake pedal 11.

The casing unit 24 is composed of a casing 40 and the electronic control circuit board 50. The casing 40 has a casing body 41 and a casing cover 42.

The casing body 41 is formed into a tray shape having an open end 41a. The casing body 41 has a bottom portion 41b (that is, the partitioning wall) and a side wall portion 41c formed at a periphery of the bottom portion 41b, wherein the bottom portion 41b and the side wall portion 41c are integrally formed of synthetic resin. The open end 41a of the casing body 41 is fluid-tightly in contact with the assembling surface 21a of the solenoid block 21. The first chamber R1 is formed between the solenoid block 21 and the casing body 41 for accommodating the solenoid valves 31.

The casing cover 42 is likewise formed into a tray shape having an open end 42a. The casing cover 42 has a bottom portion 42b and a side wall portion 42c formed at a periphery of the bottom portion 42b, wherein the bottom portion 42b and the side wall portion 42c are integrally formed of synthetic resin. The open end 42a, that is the forward end (right hand end) of the side wall portion 42c, is fixed to an outer wall surface of the bottom portion 41b by vibration welding or the like. A second chamber R2 is formed between the casing body 41 (the partitioning wall 41b) and the casing cover 42 for accommodating the electronic control circuit board 50.

As above, the casing 40 has the open end 41a, which is fluid tightly in contact with the assembling surface 21a of the solenoid block 21, to cover the solenoid valves 31. The casing 40 is detachably fixed to the solenoid block 21.

The bottom portion 41b of the casing body 41 functions as the partitioning wall 41b for separating the inside space of the casing 40 into the first and second chambers R1 and R2. The partitioning wall 41b is arranged to oppose to the control circuit board 50. Multiple dam portions 41b2 are formed on the partitioning wall 41b for surrounding the terminal portions 31b3 of the solenoid valves 31. Sealing material (for example, silicon material) is filled into the dam portions 41b2 for sealing gaps between the terminal portions 31b3 and the partitioning wall 41b.

A metal rod 61 is integrally formed with the partitioning wall 41b. The metal rod 61 is integrally and coaxially formed with a boss portion 62 formed in the partitioning wall 41b, wherein the metal rod 61 penetrates through the boss portion 62. The metal rod 62 is integrally formed with the casing body 41 (the partitioning wall 41b) by an injection molding. As shown in FIG. 2 or 4, the metal rod 61 is a bar element having a large diameter portion 61a and a small diameter portion 61b, where in the large and small diameter portions 61a and 61b are integrally formed as one element. The large diameter portion 61a is fixed to the boss portion 62.

A projected portion 61a1 is formed at an axial end of the large diameter portion 61a such that the projected portion 61a1 is coaxial with the large diameter portion 61a and inserted into a fixing hole 50a formed in the control circuit board 50. Thus, one axial end (an upper end in FIG. 2) of the metal rod 61 is fixed to the control circuit board 50.

An axial end of the small diameter portion 61b is so formed that an axial end surface thereof is placed in a plane, which is almost the same to a plane of the open end 41a of the casing body 41. A screw hole 61b1 is formed at the axial end of the small diameter portion 61b, into which a bolt 65 will be screwed, wherein the bolt 65 penetrates through a through-hole 21b of the solenoid block 21. When the bolt 65 is screwed into the screw hole 61b1, the axial end (a lower end in FIG. 2) of the metal rod 61 is firmly fixed to the solenoid block 21. As a result, the casing body 41 is fixed to the solenoid block 21. A sealing member 81 (e.g. a packing) is provided between the open end 41a of the casing body 41 (that is, the forward end of the side wall portion 41c) and the solenoid block 21, to seal any gap therebetween.

An electric conductive pattern 51 to be connected to the ground is formed on the control circuit board (the printed circuit board) 50 adjacent to the fixing hole 50a. The axial end of the large diameter portion 61a, namely the end of the metal rod 61 is in contact with the electric conductive pattern 51. An electrically conductive and heat transferring member 80 is interposed between the axial end of the large diameter portion 61a and the electric conductive pattern 51. According to such an arrangement, the electric conductive pattern 51 is electrically and thermally connected to the metal rod 61 much surely. The electrically conductive and heat transferring member 80 is made of electrically conductive paste, such as a paste having silver as a main component and metallized under a high temperature (e.g. 150° C.). The electric conductive pattern 51 is one of conductive patterns formed on the printed circuit board (control circuit board) 50, having a function of a grounded line. The electric conductive pattern 51 is, for example, the grounded line for the electric motor 22b.

The drain ports 82 are formed at a lowermost portion of the side wall portion 41c of the casing body 41. The drain port 82 is a pipe portion for communicating the first chamber R1 with the atmosphere (the outside). A shielding portion 83 is formed in the inside of the casing body 41 to cover the drain port 82. The shielding portion 83 blocks off any fluid (water), which otherwise comes from the outside into the first chamber R1 through the drain ports 82. The shielding portion 83 extends from the partitioning wall 41b in a perpendicular direction to the partitioning wall 41b (i.e. towards the solenoid block 21). A small gap is formed between a forward end of the shielding portion 83 and the solenoid block 21. If the pressure in the first chamber R1 became to a negative value and an open end (a lower end) of the drain port 82 was exposed to the water, the water may come into the first chamber R1 through the drain ports 82. A maximum water level Lh in this case is decided by a maximum value of the negative pressure and a volume of the first chamber R1. The water level Lh is defined here as a height (level) of the water measured from a lowermost point of the casing body 41.

A supporting portion 60 is composed of the above mentioned metal rod 61 and the boss portion 62. A labyrinth structure 70 is formed in the supporting portion 60. The labyrinth structure 70 communicates the first and second chambers R1 and R2 with each other, but prevents the water from directly flowing from the first chamber R1 into the second chamber R2. The labyrinth structure 70 is formed by a communication groove 71 formed at an outer peripheral surface of the large diameter portion 61a of the metal rod 61, a cylindrical shielding wall 62a extending from the boss portion 62 towards the solenoid block 21, and so on.

The communication groove 71 extends from a step portion 61c formed between the large diameter portion 61a and the small diameter portion 61b to a notch 62b formed at the boss portion 62. The notch 62b is formed by notching a portion of the boss portion 62, which protrudes into the second chamber R2. The notch 62b is preferably formed at such a position of the boss portion 62, which is an upper side thereof in a vertical direction.

The cylindrical shielding wall 62a extends from an axial peripheral end of the boss portion 62 protruding into the first chamber R1. A gap S between a forward end of the shielding wall 62a and the solenoid block 21 is designed to be a small value. As shown in the drawings, the cylindrical shielding wall 62a is integrally formed with the boss portion 62 and extends in an axial direction along the metal rod 61, so that the shielding wall 62a covers an open end of the communication groove 71 on a side of the first chamber R1. As above, the labyrinth structure 70 forms a passage, which comprises the gap S, a space between the cylindrical shielding wall 62a and the small diameter portion 61b, and a space between the boss portion 62 and the communication groove 71.

According to the above structure, even when the water may come into the first chamber R1 and the water is spattered in the first chamber R1 due to a vertical vibration during a vehicle running, the spattered water is blocked off by the cylindrical shielding wall 62a. Thus, the water is prevented from directly flowing into the communication groove 71. Furthermore, since the gap S is designed to be the small value, the amount of water flowing into the labyrinth structure 70 can be suppressed to a minimum value.

A step portion 62a1 is formed at an inner peripheral surface of the cylindrical shielding wall 62a. The step portion 62a1 is formed between the boss portion 62 and the shielding wall 62a. As described above, the step portion 61c is also formed at the outer peripheral surface of the metal rod 61 between the large diameter portion 61a and the small diameter portion 61b. The step portion 62a1 is formed at such a position, which coincides with the step portion 61c in the axial direction. Accordingly, the open end of the communication groove 71 on the side of the first chamber R1 terminates at the step portions 61c and 62a1, which are respectively formed at the outer peripheral surface of the rod 61 and the inner peripheral surface of the cylindrical shielding wall 62a. Needless to say, the step portion may not necessarily be formed at both peripheral surfaces, but may be formed at either one of the outer peripheral surface of the rod 61 or the inner peripheral surface is of the cylindrical shielding wall 62a. According to the above structure, the water is prevented by the step portions 62a1 and/or 61c from directing flowing into the communication groove 71, even when the water comes into the space between the cylindrical shielding wall 62a and the small diameter portion 61b through the gap S and approaches to the communication groove 71 along the outer peripheral surface of the rod 61 and/or the inner peripheral surface of the cylindrical shielding wall 62a.

The open end of the communication groove 71 on the side of the first chamber R1 is covered by a pair of ribs 62c, which are formed at both sides of the open end. The ribs 62c are formed at the inner peripheral surface of the cylindrical shielding wall 62a next to the step portion 61c and extend in a radial direction from the inner peripheral surface of the cylindrical shielding wall 62a. Each radial end of the ribs 62c is in contact with the outer peripheral surface of the small diameter portion 61b of the metal rod 61. Accordingly, the water is prevented by the ribs 62c from directing flowing into the communication groove 71, even when the water in the space between the cylindrical shielding wall 62a and the small diameter portion 61b is spattered due to the vibration.

The labyrinth structure 70 is arranged at such a position, which is even higher in the vertical direction than the maximum water level Lh, which is the water level achieved when the pressure in the first chamber R1 becomes to the negative value. Accordingly, the water level may not reach at such a height of the labyrinth structure 70, even when the water comes into the first chamber R1 as a result that the pressure in the first chamber R1 becomes to the negative value. Consequently, the water is surely prevented from flowing into the second chamber R2.

Multiple stays 41b1 are formed at the partitioning wall 41b for supporting the printed circuit board (control circuit board) 50, wherein the stays 41b1 are integrally formed with the casing body 41. The stays 41b1 have a function for positioning the printed circuit board 50 in a longitudinal direction.

The control circuit board 50 forms an electronic control unit, which performs vehicle control operations, such as a normal braking operation, an anti-lock braking operation (ABS), a vehicle stability control (ESC), and soon. For that purpose, the electronic control unit controls the electric motor 22b and the solenoid valves 31 in accordance with signals, for example a signal from a wheel speed sensor (not shown) for detecting a wheel speed of the vehicle wheel W.

In the vehicle hydraulic braking system 10 of the above structure, the fluid pressure from the fluid pressure source is applied to the respective wheel cylinders 15 during the normal braking operation. The brake actuators 23 independently control the fluid pressure applied to the respective wheel cylinders 15, so that the operations for the anti-lock braking control, the vehicle stability control, the traction control, and so on can be carried out by the vehicle hydraulic braking system 10.

An assembling process for the braking pressure control unit 13 will be explained. The sealing material is filled into the dam portions 41b2. The electrically conductive and heat transferring material 80 is applied to the axial end surface of the large diameter portion 61a of the metal rod 61. The projected portion 61a1 of the metal rod 61 is inserted into the fixing hole 50a of the control circuit board 50. At the same time, terminals 41d1 for a connector 41d are inserted into corresponding holes formed in the control circuit board 50. Thus, the control circuit board 50 is fixed to the casing body 41.

The solenoid valves 31 are separately assembled (fixed) to the solenoid block 21. Then, the solenoid block 21 is assembled to the pump block 22 to complete the brake actuator 23.

The casing body 41, to which the control circuit board 50 is fixed, is assembled to the brake actuator 23. Then, the bolt 65 is firmly screwed into the metal rod 61, so that the casing body 41 is fixed to the brake actuator 23. The terminal portions 31b3 of the solenoid valves 31 are inserted into the corresponding holes formed in the control circuit board 50.

One side surface (an opposite surface to the partitioning wall 41b) of the control circuit board 50 is dipped into a soldering tray, so that the terminals 31b3 of the solenoid valves 31 and the terminals 41d1 of the connector 41d are connected to the control circuit board 50 by soldering. The control circuit board 50 is thereby further firmly fixed to the casing body 41. Thereafter, the casing cover 42 is fixed to the casing body 41 by the vibration welding or the like.

As understood from the foregoing explanation, one end of the metal rod 61 (which is integrally formed with the partitioning wall 41b of the casing unit 24) is fixed to the control circuit board 50. This means that the control circuit board 50 is fixed is to the casing unit 24 by the metal rod 61. The other end of the metal rod 61 is fixed to the solenoid block 21, so that the casing unit 24 is fixed to the solenoid block 21 by the metal rod 61. Thus, both of the control circuit board 50 and the casing unit 24 are fixed to the solenoid block 21 by one member (the metal rod 61), namely the control circuit board 50 and the casing unit 24 can be fixed to the solenoid block 21 with a simple structure and with a small number of parts.

Furthermore, since the metal rod 61 is fixed to the solenoid block 21 by the bolt 65, the control circuit board 50 and the casing unit 24 can be surely fixed to the solenoid block 21 by a simple method.

As already explained above, in the conventional braking pressure control unit (as disclosed in Japanese Patent Publication No. 2000-159081), the number of parts is increased to increase the cost, and the assembling process is not simple.

According to the above embodiment of the present invention, however, the one axial end of the metal rod 61 is brought into contact with the ground conductive pattern 51 formed on the control circuit board 50. The increase for the number of parts is suppressed, the increase of the cost is thereby suppressed, and the assembling process is made simpler. Namely, the ground conductive pattern 51 can be connected to the ground through the metal rod 61 and the solenoid block 21.

The electrically conductive and heat transferring material 80 is interposed between the axial end of the metal rod 61 and the electric conductive pattern 51. Accordingly, the electrical conduction and the heat transfer can be much more surely carried out between them.

In the other conventional braking system (Japanese Patent No. 3,365,055), as already explained above, the size of the braking pressure control unit is inevitably made larger, and a number of parts is increased and thereby the cost becomes higher.

According to the above embodiment of the present invention, however, the one axial end of the metal rod 61 is brought into contact with the ground conductive pattern 51 formed on the control circuit board 50. As a result, the increase for the number of parts is suppressed, the cost increase is thereby suppressed, and the assembling process is made simpler. Namely, the heat generated at the control circuit board 50 is transferred to the solenoid block through the ground conductive pattern 51 and the metal rod 61, so that the heat is effectively radiated.

In the other conventional braking system (Japanese Patent Publication No. 2002-193086), as already explained above, it is a problem that a number of parts is increased and the cost becomes higher.

According to the above embodiment of the present invention, however, the metal rod 61 is inserted into the boss portion 62 formed in the partitioning wall 41b, so that the supporting portion 60 is formed by the metal rod 61 and the boss portion 62. The first and second chambers R1 and R2 are communicated with each other. The labyrinth structure 70 is formed in the supporting portion 60, so that the water (which has come into the first chamber R1) is prevented from directly flowing into the second chamber R2. According to the present invention, therefore, a separate water proof structure is not necessary. Namely, it is possible to prevent the water from directly flowing into the second chamber R2, without making larger the size of the braking pressure control unit.

The labyrinth structure 70 is arranged at such a position, which is higher than the maximum water level Lh, when the pressure in the first chamber R1 is negative and the water comes into the first chamber R1. Therefore, the water may not come to the height of the labyrinth structure 70, even when the pressure in the first chamber R1 becomes negative and the water has come into the first chamber R1. Accordingly, the water is surely suppressed from directly flowing into the second chamber R2.

The labyrinth structure 70 has the communication groove 71 formed at the outer peripheral surface of the metal rod 61. Therefore, a length of the communication groove 71 can be made longer, so that the water is furthermore surely suppressed from directly flowing into the second chamber R2.

Furthermore, the labyrinth structure 70 has the cylindrical shielding wall 62a, which is integrally formed with the boss portion 62 and extends in the axial direction along the metal rod 61, so that the shielding wall 62a covers the open end of the communication groove 71 on the side of the first chamber R1. Accordingly, the water is surely suppressed by the shielding wall 62a from directly flowing into the second chamber R2.

The open end of the communication groove 71 on the side of the first chamber R1 terminates at the step portions 61c and 62a1, which are respectively formed at the outer peripheral surface of the rod 61 and the inner peripheral surface of the cylindrical shielding wall 62a. Accordingly, the water is suppressed by the step portions 62a1 and/or 61c from directing flowing into the communication groove 71, even when the water approaches to the communication groove 71 along the outer peripheral surface of the rod 61 and/or the inner peripheral surface of the cylindrical shielding wall 62a.

In the above embodiment, the projected portion 61a1 of the metal rod 61 is inserted into the fixing hole 50a formed on the control circuit board 50, so that the control circuit board 50 is fixed to the metal rod 61 and then to the casing body 41. However, the control circuit board 50 may be fixed to the metal rod 61 (and to the casing body 41) by a screw a4, as shown in FIG. 6. In such a modification, a screw hole 61a2 is formed at one end of the large diameter portion 61a of the metal rod 61, so that the screw 84 is screwed into the screw hole 61a2. In this modification, since the ground conductive pattern 51 is firmly pressed against the axial end of the large diameter portion 61a of the metal rod 61, the electrically conductive and heat transferring member 80 may be eliminated.

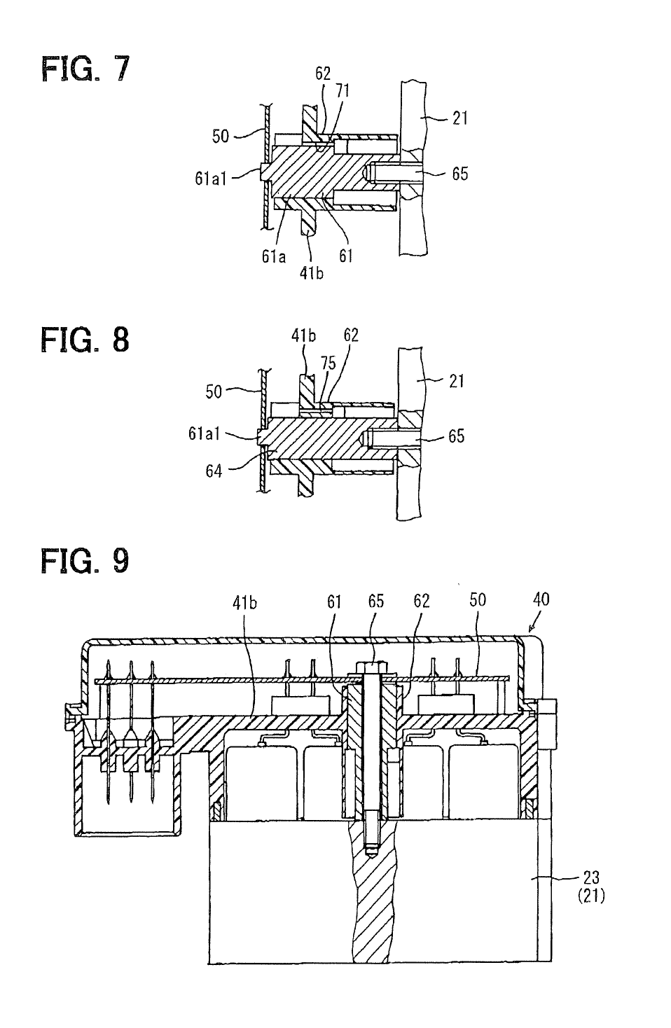

In the above embodiment, the communication groove 71 is formed at the outer peripheral surface of the metal rod 61. However, the communication groove 71 may be formed at the inner peripheral surface of the boss portion 62, as shown in FIG. 7. According to such modification, it is not necessary to carryout a cutting process to the metal rod 61, and therefore, a corresponding cost reduction can be expected.

Furthermore, a communication hole 75 may be formed in the boss portion 62, instead of the communication groove 71, as shown in FIG. 8. In this modification, the communication hole 75 is formed such that it extends in an axial direction, and a metal rod 64 is formed as a straight metal bar having no large diameter or small diameter portions. Accordingly, a further cost reduction can be achieved.

As above, the labyrinth structure 70 has the communication groove 71 or the communication hole 75, which is formed at either the metal rod 61 or the boss portion 62. Namely, the length of the communication groove 71 or the communication hole 75 can be made longer, so that water may not easily flow into the second chamber R2.

In the above embodiment, the casing body 41 is fixed to the solenoid block 21, wherein the bolt 65 is inserted through the solenoid block 21 and screwed into the metal rod 61. However, the bolt 65 may be inserted through the metal rod 61 and screwed into the solenoid block 21, in order to fix the casing body 41 to the solenoid block 21, as shown in FIG. 9. According to such a modification, the manufacturing process for the solenoid block 21 and the pump block 22 can be simplified to reduce the cost. In addition, a flexibility for the layout of the solenoid block 21 and the pump block 22 is increased.

It is preferable to provide one metal rod 61 at a center of the first chamber R1. Four fixing points, which are separately provided in the conventional system, can be put together to one position according to the present invention. A space for fixing the control circuit board 50 to the casing body 41 can be reduced, and thereby the braking pressure control unit can be miniaturized.

What is claimed is:

1. A braking pressure control unit for a vehicle braking system comprising:
a block having an assembling side, to which multiple electromagnetic valves for performing brake control operation of a vehicle are attached;
a control circuit board for controlling operations of the electromagnetic valves;
a casing made of synthetic resin and fixed to the block for covering the electromagnetic valves, wherein the casing has an open end fluid-tightly fixed to the assembling side of the block;
a partitioning wall for defining, within a space of the casing, a first chamber for accommodating the electromagnetic valves and a second chamber for accommodating the control circuit board, the partitioning wall being made of synthetic resin and opposing to the control circuit board; and
a metal rod integrally formed with the partitioning wall, wherein one end of the metal rod is fixed to the control circuit board whereas the other end of the metal rod is fixed to the block.

2. A braking pressure control unit according to claim 1, wherein the metal rod is fixed to the block by a bolt.

3. A braking pressure control unit according to claim 1, wherein
one axial end of the metal rod is in contact with a ground conductive pattern formed on the control circuit board.

4. A braking pressure control unit according to claim 3, wherein
an electrically conductive and heat transferring material is interposed between the one axial end of the metal rod and the ground conductive pattern.

5. A braking pressure control unit according to claim 1, wherein
the metal rod is integrally formed with a boss portion provided at the partitioning wall, wherein the petal rod penetrates through the boss portion,
a supporting portion is formed by the metal rod and the boss portion, and
a labyrinth structure is formed in the supporting portion, wherein the labyrinth structure communicates the first and second chambers with each other and prevents water from directly flowing into the second chamber from the first chamber.

6. A braking pressure control unit according to claim 5, wherein
the labyrinth structure is arranged at such a position, which is higher than a maximum water level, which may be achieved when pressure in the first chamber becomes negative and water comes into the first chamber.

7. A braking pressure control unit according to claim 5, wherein
the labyrinth structure has a communication groove or a communication hole, which is formed at least at one of the boss portion and the metal rod.

8. A braking pressure control unit according to claim 7, wherein
the labyrinth structure has a cylindrical shielding wall, which is integrally formed with the boss portion and extends in the axial direction along the metal rod, so that the shielding wall covers an open end of the communication groove or the communication hole on a side of the first chamber.

9. A braking pressure control unit according to claim 7, wherein
a step portion is formed at an open end of the communication groove or the communication hole on a side of the first chamber, wherein the step portion is formed at an outer peripheral surface of the metal rod.

10. A braking pressure control unit according to claim 8, wherein
a step portion is formed at an open end of the communication groove or the communication hole on the side of the first chamber, wherein the step portion is formed at an outer peripheral surface of the metal rod or an inner peripheral surface of the cylindrical shielding wall.

11. A braking pressure control unit for a vehicle braking system comprising:
a brake actuator having multiple solenoid valves for opening or closing fluid passages so that brake fluid pressure to be applied to respective wheel cylinders is controlled, each one end of the solenoid valves outwardly protrudes from one side surface of a solenoid block made of metal;
a cup-shaped casing body made of synthetic resin and having an open end fixed to the solenoid block so as to form a first chamber for accommodating the protruded ends of the solenoid valves;
a drain port formed in the cup-shaped body at a lower side thereof;
a cup-shaped casing cover made of synthetic resin and having an open end fixed to a bottom portion of the cup-shaped casing body so as to form a second chamber for accommodating a printed circuit board;
a boss portion formed in the bottom portion of the cup-shaped casing body;
a metal rod penetrating through and fixed to the boss portion, one axial end of the metal rod being fixed to the printed circuit board and the other end thereof being fixed to the solenoid block; and
a labyrinth structure formed at a supporting portion, which is composed of the boss portion and the metal rod, for communicating the first and second chambers with each other.

12. A braking pressure control unit according to claim 11, wherein
the one axial end of the metal rod is fixed to an almost center portion of the printed circuit board.

13. A braking pressure control unit according to claim 11, wherein
the metal rod has a large diameter portion and a small diameter portion, wherein the large diameter portion is fixed to the boss portion of the cup-shaped casing body.

14. A braking pressure control unit according to claim 11, wherein
the labyrinth structure has a communication groove or a communication hole formed in the large diameter portion.

15. A braking pressure control unit according to claim 11, wherein
the metal rod is made of a straight bar member, and the labyrinth structure has a communication hole formed in the large diameter portion.

16. A braking pressure control unit according to claim 11, wherein
a through-hole is formed in the solenoid block, and
a bolt is inserted into the trough-hole from a side opposite to the side surface of a solenoid block, from which the ends of the solenoid valves outwardly protrude,
wherein the bolt is screwed into the metal rod.

17. A braking pressure control unit according to claim 11, wherein
a through-hole is formed in the metal rod, and
a bolt is inserted into the trough-hole from the printed circuit board, such that a forward end thereof is screwed into a screw hole formed in the solenoid block.

18. A braking pressure control unit according to claim 11, wherein
a shielding portion is integrally formed with the casing body at such a position between the drain port and the solenoid valves.
